(19) United States
(12) Patent Application Publication
(10) Pub. No.: US 2009/0265252 A1
(43) Pub. Date: Oct. 22, 2009

(54) MONEY POOLING WITH ELECTRONIC INVOICE

(76) Inventor: Charles Dale Fletcher, San Jose, CA (US)

Correspondence Address: SCHWEGMAN, LUNDBERG & WOESSNER/EBAY, P.O. BOX 2938, MINNEAPOLIS, MN, 55402, US

(21) Appl. No.: 12/106,647

(22) Filed: Apr. 21, 2008

(51) Int. Cl. G06Q 30/00; G06F 3/048; G06F 15/16

(52) U.S. Cl. 705/26; 715/780; 709/203

(57) ABSTRACT

An electronic invoice is associated with a transaction code. The electronic invoice may be provided by a merchant. The transaction code may be generated by a payment processing system. Two or more consumers may retrieve the electronic invoice using the transaction code. Based on the electronic invoice, the consumers may use the payment processing system to pay the merchant.

### TECHNICAL FIELD

The present application relates generally to the technical field of data processing and, in one specific example, to a method and system of conducting payment transactions.

### BACKGROUND

When payment transactions are associated with a group of people sharing the same invoice, it is often difficult to divide and determine who is responsible for what portion of the invoice. For example, when a group of friends dine together at a restaurant, it is easier for the restaurant to present a single invoice or bill to the group instead of multiple individual invoices. It is then up to the group to decide how to divide the invoice and how much each person in the group has to contribute. When the contributions from everyone are collected, a single payment is presented to the restaurant. This approach is often confusing and normally end up with someone paying more or less than that person is supposed to pay. This approach is also inefficient because each person may have a different preferred method of payment. For example, when there are two persons in the group and neither has cash but both have credit cards, then the invoice may be paid by using one person's credit card while the other person may have to owe the paying person. This places a burden on the paying person to collect the debt. It may also place the owing person in an embarrassing situation because a debt exists.

### BRIEF DESCRIPTION OF THE DRAWINGS

Some embodiments are illustrated by way of example and not limitation in the figures of the accompanying drawings in which:

FIG. 1 illustrates a network diagram depicting a system, according to an example embodiment, having a client-server architecture.

FIG. 2 illustrates a block diagram showing marketplace and payment application(s) in an example embodiment.

FIG. 3 illustrates a high-level diagram of the payment processing applications, in accordance with some example embodiments.

FIG. 4A is a diagram that illustrates examples of information flow, in accordance with some example embodiments.

FIG. 4B illustrates an example of a user interface that may be used with a client/consumer system, in accordance with some example embodiments.

FIG. 4C illustrates a high-level entity-relationship diagram, having various tables that may be maintained within a database, in accordance with some example embodiments.

FIG. 5 is a flow chart illustrating an example process for generating a transaction code and providing the transaction code to a consumer, in accordance with some example embodiments.

FIG. 6 is a flow chart illustrating an example process for using a payment facilitator and a transaction code to pay an invoice, in accordance with some example embodiments.

FIG. 7 is a flow chart illustrating an example process for using a payment facilitator and a transaction code to pool multiple payments, in accordance with some example embodiments.

FIG. 8 illustrates a diagrammatic representation of a machine in the form of a computer system within which a set of instructions, for causing the machine to perform any one or more of the methodologies discussed herein, may be executed, according to an example embodiment.

### DETAILED DESCRIPTION

Example methods and systems to conduct payment transactions via electronic invoices and pooling payments are described. The method comprises associating an electronic invoice with a transaction code. The electronic invoice may be provided by a merchant via a merchant computer system (or merchant system). The transaction code may be generated by a payment processing system, which may be associated with a payment facilitator. The transaction code may be provided to a group of one or more consumers who are collectively responsible for the electronic invoice. A consumer may retrieve the electronic invoice using the transaction code. The consumer may then authorize the payment facilitator using the transaction code to pay the consumer's portion of the electronic invoice. The consumer may use a computer system to receive one or more of the electronic invoice and the transaction code.

In the following description, for purposes of explanation, numerous specific details are set forth in order to provide a thorough understanding of example embodiments. It will be evident, however, to one skilled in the art that the present invention may be practiced without these specific details.

### Architecture

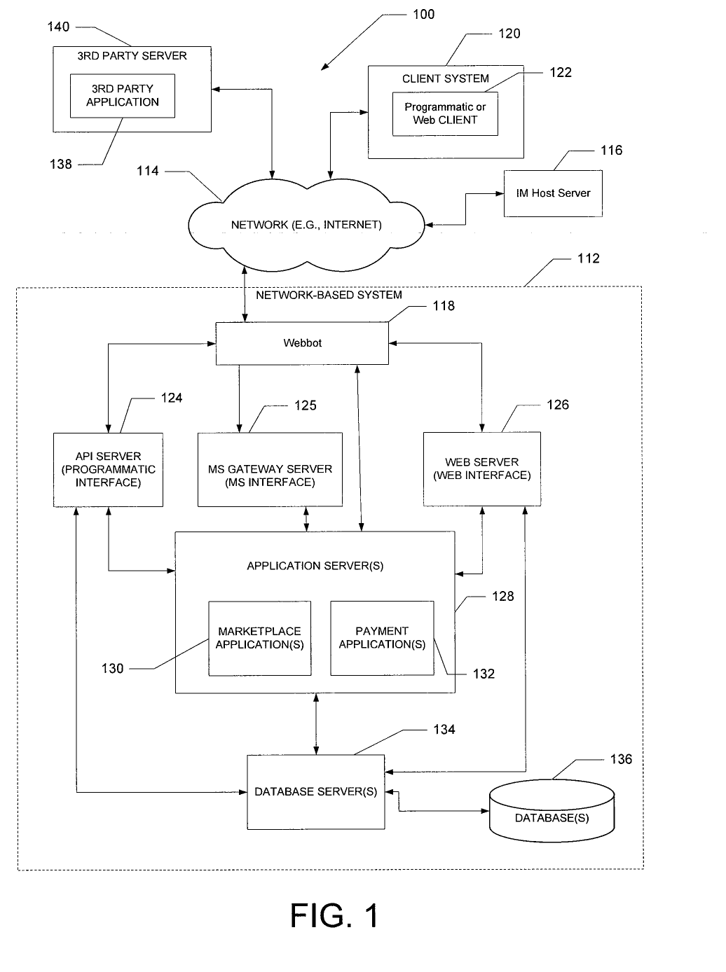

FIG. 1 illustrates a network diagram depicting a system 100 having a client-server architecture, according to an example embodiment of the present invention. A system, in the example form of a network-based system 112, provides server-side functionality, via a network 114 (e.g., the Internet, a public or private telephone network (wireline or wireless), a private wireless network using technologies such as Bluetooth or IEEE 802.11x or other networks) to one or more clients. FIG. 1 illustrates, for example, a programmatic/web client 122 may include a browser (e.g., the Internet Explorer® browser developed by Microsoft®), a device application, and/or a programmatic client executing on client system 120, e.g., on a network-based device. Further, while the system 100 shown in FIG. 1 employs a client-server architecture, embodiments are of course not limited to such an architecture, and could equally well find applications in a distributed, or peer-to-peer, architecture system.

The network 114 may include a mobile telephone network, a wireless wide area network (WWAN), a wireline telephone network, a wireless local area network (wireless LAN or WLAN), a wireless Metropolitan Area Network (MAN), and/or a wireless personal area network (PAN) (e.g., a Bluetooth® network). Other network-based technologies that may be used to connect include PON, VSAT satellite, Micro-impulse Radar, Radio Frequency identification (RFID), UltraWide Band, and/or Infrared. The network-based device may connect to the web using mobile internet exchange, e.g. Wireless Application Protocol (WAP) and/or Hypertext Transport Protocol (HTTP).

The client system (or network-based device(s)) 120, may include a mobile device, a palmtop computer, a laptop computer, a desktop computer, a personal digital assistant, a cellular telephone, a communications device, a wireless telephone, a land-line telephone, a control system, a camera, a scanner, a television, television cable, a telephone with a web browser, a facsimile machine, a printer, a pager, and/or a personal trusted device. There may be one or more client systems 120.

The client system 120 may include a card, such as a smart card, a magnetic card, and/or a key card. The device may include a telephone or any device capable of Short Messaging Service (SMS) messaging, instant messaging (IM), text messaging, multimedia messaging service (MMS) messaging and/or generating audio tones, such as dual-tone multi-frequency (DTMF) tones. The device may be browser-enabled. The client system 120 may enable mobile videophone communications, digital television signals, and/or digital radio signals. The device may include a receiver to receive near field communications. The scanner device may include a bar code reader/scanner, a Radio Frequency Interface System (RFIS) reader, and/or a symbol reader/scanner.

For some example embodiments, the client system 120 may be used by a consumer to authorize a payment facilitator to pay a portion of an electronic invoice.

The client system 120 may engage in an interactive message and/or open communication session, such as SMS, IM, electronic mail, xHTML, XML, Wireless Application Protocol (WAP), web, interactive voice response (IVR) and/or other mobile interfaces. The interactive messaging or open communication session may involve multiple technology modalities, e.g., the client user may engage the system via IM and receive a responsive communication from the network-based system 112 via e-mail with an embedded hyperlinked URL directing the client user's device to a WAP or web page or via a telephone call. A hyperlinked URL may be delivered directly to the device from one or more application server(s) 128 of network-based system 112 and may be used to access a web site or a microbrowser, such as a WAP site.

Turning specifically to the network-based system 112, the one or more application servers 128 may host one or more marketplace application(s) 130 and one or more payment application(s) 132.

The marketplace application(s) 130 may provide a number of marketplace functions and services to client users, such as a buyer, and/or to third parties, such as sellers, vendors, or any user, who access the network-based system 112. The marketplace applications 130 may provide a number of offering mechanisms and price-setting mechanisms; whereby a seller may list goods or services for sale, a seller may promote their offers, a buyer can express interest in or indicate a desire to purchase such goods or services or to donate, and a price can be set for a transaction pertaining to the goods or services.

Payment applications 132 may provide a number of payment services and functions to users. While the marketplace and payment applications 130 and 132 are shown in FIG. 1 to both form part of the network-based system 112, it will be appreciated that, in alternative embodiments, the payment applications 132 may form part of a payment service that is separate and distinct from the network-based system 112.

In the instance where the client system 120 accesses the marketplace applications 130 and payment applications 132 via the MS Interface, the client system 120 may use an “instant messaging” service via an IM Host server 116 for substantially instant messaging. In example embodiments, the IM host server 116 may be selected from a group including Skype®, Yahoo® IM, AIM® of AOL®, MSN® Messenger of Microsoft®, and ICQ® of the ICQ Network. The IM Host server 116 may be included within the network-based system 112 and therefore enable secure transactions with the application server(s) 128, and may specifically be included within the payment application(s) 132.

The client system 120 may access the application servers 128, such as the various marketplace applications 130 and payment applications 132, via a Webbot 118, and via a system interface. The Webbot 118 may be a dynamic Web page object evaluated when the webpage is opened in a Web browser or saved. In example embodiments, the Webbot 118 includes a Jabber® host or server interface. The Webbot 118 may be a streaming XML technology that may be used for instant messaging. The Webbot 118 may be open-source, neutral, and universal to enable communications between the network-based system 112 and any server, such as the IM host server 116. Further, the Webbot 118 may be decentralized (i.e., located within the network-based system 112) and therefore enable secure transactions between the client system 120 and the network-based system 112.

Decentralizing the Webbot may enable secure transactions. In particular, the information may be encrypted because an application may be on the client's machine, where information may be encrypted without network exposure.

The system interface between the client system 120 and the applications 130 and 132 may include a programmatic interface supported by an Application Program Interface (API) server 124, a Messaging Service (MS) Interface supported by an MS Gateway Server 125, and/or a web interface supported by a web server 126. The web interface may include a web browser or any microbrowser, such as xHTML or WAP. Similarly, the programmatic/web client 122 accesses the various services and functions provided by the application server(s) 128, via the programmatic interface provided by the API server 124 and/or the web server 126. The programmatic/web client 122 may, for example, be a seller application (e.g., TurboLister® application) to enable sellers to author and manage listings on the network-based system 112 in an off-line manner, and to perform batch-mode communications between the programmatic/web client 122 and the network-based system 112.

In an additional embodiment, an application supported by one or more applications of the application server(s) may be downloadable to the network-based device. The device(s) may host the interface associated with the one or more applications of the application server(s) 128. The interface on the device may be an API interface, an MS interface, a web interface, and/or another appropriate communication interface. Consumer wireless device platforms, such as Java 2 Platform Micro Edition (J2ME), J2SE and J2EE allow developers to use Java and a wireless toolkit to create applications and programs for the client system 120. The J2ME interface may include an application programming interface (API) for the device. The application of the programmatic client may also access the Internet using, for example, Binary Runtime Environment for Wireless (BREW).

The programmatic/web client 122 executed on the client system 120 may access the application server(s) 128 via the web interface of the web server. The programmatic/web client 122 may be selected on the client system 120 which may cause the Internet to be launched in a background process. The programmatic/web client 122 may additionally or alternatively access the server(s) 128 via the MS interface of the MS Gateway server 125, and/or via the programmatic interface of the API server 124. In an embodiment, the downloaded application described herein may include the programmatic/web client 122.

The client system 120 may host the interface associated with one or more payment application(s) 132 of the server(s) 128. The programmatic/web client 122 may be associated with a financial service provider (FSP) of the payment application(s). In an additional embodiment, the programmatic/web client 122 may be associated with a third party application 138 of a third party server 140. The third party application may, for example, provide one or more promotional, marketplace or payment functions that are supported by the relevant applications of the network-based system 112. For some example embodiments, the third party application may generate an electronic invoice and may transmit the electronic invoice to the payment applications 132 for processing.

The payment application(s) and/or the FSP may operate independent of the third party. The payment application(s) and/or the FSP may be related to the third party, in other embodiments.

The payment applications 132 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 130. The payment applications 132, e.g., a financial service provider, may also extend credit to user, and/or may also have access to other funding sources to complete transactions—e.g. a credit card, a bank account, and/or a credit line. The FSP may operate using the payment application(s) 132.

The WebBot 118 may be part of the payment application(s) 132 in some embodiments. In an example, through the WebBot 118, and in response to a prompt from an application executed on the client system 120, the user may submit a payment transaction request to the payment application(s). A payment transaction from a user to a third party vendor may then be created. The payment application(s) 132 may send a payment confirmation message, e.g., via IM and the IM host server 116, to the user and/or the third party vendor.

The third party or vendor may receive, from the payment application(s) and/or the FSP, information regarding a requested payment transaction for a product, a service, or a donation amount, information regarding the shipment address specified by the client user, and payment confirmation. The payment application(s) and/or the financial service provider may secure financial information of the client user with respect to the third party. The FSP may not be sharing the financial information of the client user with the third party. For example, the payment may be received by the third party exclusive of the payment method and/or financial information of the client user, including credit card information, bank information and/or other client user account information.

The network-based system 112 and the various marketplace and payment applications 130 and 132 may also be implemented as standalone software programs, which do not necessarily have networking capabilities. In this example, the client system 120 may be directly connected to the marketplace application(s) 130 and/or payment application(s) 132, without using the network 114. In other examples, the network-based system 112 may be any online marketplace (e.g., eBay marketplace, etc.)

The application server(s) 128 may be coupled to one or more database servers 134 that facilitate access to one or more databases 136. The application(s) may have access to the database(s) 136 having, for example, personal user account information. The user account information may include payment information associated with the client user and an address destination of the client user, for example.

The programmatic/web client 122 may operate a program supported by the one or more database server(s) 134. The database server(s) 134 may support one or more account information links on a user interface of the network-based device, for example, using the programmatic/web client 122. By accessing the database server(s) 134, the client user may add, amend or delete account information of the client user, among other information. In an embodiment, the client user may select a default shipment address and a default payment method in the payment application(s) discussed herein. Depending on whether goods are purchased, a service is requested, a donation is made, or a promotion is selected, a default shipment address, e.g. electronic mail address or a residential address, a business addresses, or a P.O. Box, may be selected by the client user in the payment application(s). One of the default payment methods may include direct transfers from system account balances, internal credit, a gift certificate, a bank account, a debit card, buyer credit, and/or a credit card.

The payment application(s) 132 may transfer funds (or other value) between users. The payment application 132 may, responsive to the server(s) receiving a payment transaction request from the user, transfer a payment from the user to the third party. The payment may be automatically transferred, as discussed herein.

For some example embodiments, the payment applications 132 may be associated with a payment facilitator (e.g., PayPal®), the third party server 140 may be associated with a merchant (e.g., a restaurant), and the users may be consumers or clients of the merchant. For some example embodiments, the payment transaction request from the user may be associated with a transaction code generated by the payment applications 132 and an electronic invoice generated by the third party server 140.

In an example embodiment of the present invention, a buyer or a consumer may be a client user that submits a purchase request, such as a purchase initiation code associated with a promotion offer, for example, or associated with an offer of an online marketplace or another marketplace medium, to the FSP. The user may submit the purchase initiation code through the network-based device while in an established communication session with the payment application 132. The communication session may include an instant message communication session, or a telephone call, or a website, for instance. The user may be requested to submit verification of identity, such as a password and username, upon making the purchase request, as discussed herein. Payment in connection with the request may be made using the FSP, for example, by debiting a first user account and crediting a second user account (or vendor account), accordingly. A means for transferring the payment is through the payment application 132.

### Application Server(s)

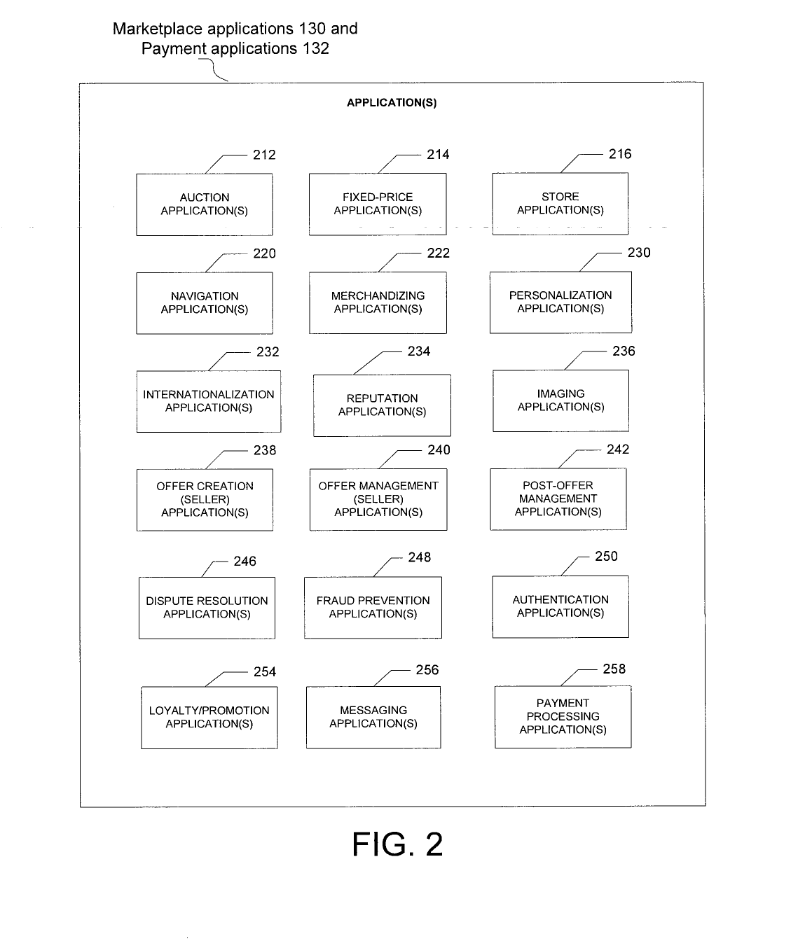

FIG. 2 illustrates a block diagram showing application server(s) that are part of the network-based system 112, in an example embodiment of the present invention. In this embodiment, the marketplace application(s) 130, and the payment application(s) 132 may be hosted by the application server(s) 128 of the network-based system 112. The marketplace application(s) 130 and the payment application(s) 132 may be hosted on dedicated or shared server machines (not shown) that are communicatively coupled to enable communications between server machines. The applications themselves may be communicatively coupled (e.g., via appropriate interfaces) to each other and to various data sources, so as to allow information to be passed between the applications or so as to allow the applications to share and access common data.

The marketplace application(s) 130 are shown to include at least one or more auction applications 212 which support auction-format listing and price setting mechanisms (e.g., English, Dutch, Vickrey, Chinese, Double, Reverse auctions etc.). The auction applications 212 may also provide a number of features in support of such auction-format listings, such as a reserve price feature whereby a seller may specify a reserve price in connection with a listing and a proxy-bidding feature whereby a bidder may invoke automated proxy bidding. The auction-format offer in any format may be published in any virtual or physical marketplace medium and may be considered the point of sale for the commerce transaction between a seller and a buyer (or two users).

One or more fixed-price application(s) 214 support fixed-price listing formats (e.g., the traditional classified advertisement-type listing or a catalogue listing) and buyout-type listings. Specifically, buyout-type listings (e.g., including the Buy-It-Now® (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

The application(s) of the application server 128 may include one or more store application(s) 216 that allow a seller to group listings within a “virtual” store. The virtual store may be branded and otherwise personalized by and for the seller. Such a virtual store may also offer promotions, incentives and features that are specific and personalized to a relevant seller.

Navigation of the online marketplace may be facilitated by one or more navigation applications 220. For example, a search application (as an example of a navigation application) may enable key word searches of listings published via the network-based system 112. A browse application may allow users to browse various category, catalogue, or inventory data structures according to which listings may be classified within the network-based system 112. Various other navigation applications may be provided to supplement the search and browsing applications.

Merchandizing applications 222 support various merchandising functions that are made available to sellers to enable sellers to increase sales via the network-based system 112. The merchandizing applications 222 also operate the various merchandising features that may be invoked by sellers, and may monitor and track the success of merchandising strategies employed by sellers.

Personalization applications 230 allow users of the network-based system 112 to personalize various aspects of their interactions with the network-based system 112. For example, a user may, utilizing an appropriate personalization application 230, create a personalized reference page at which information regarding transactions to which the user is (or has been) a party may be viewed. Further, the personalization application(s) 230 may enable a third party to personalize products and other aspects of their interactions with the network-based system 112 and other parties, or to provide other information, such as relevant business information about themselves.

The marketplace application(s) 130 may include one or more internationalization applications 232. In one embodiment, the network-based system 112 may support a number of marketplaces that are customized, for example, for specific geographic regions. A version of the network-based system 112 may be customized for the United Kingdom, whereas another version of the network-based system 112 may be customized for the United States. Each of these versions may operate as an independent marketplace, or may be customized (or internationalized) presentations of a common underlying marketplace. The network-based system 112 may accordingly include a number of internationalization applications 232 that customize information (and/or the presentation of information) by the network-based system 112 according to predetermined criteria (e.g., geographic, demographic or marketplace criteria). For example, the internationalization applications 232 may be used to support the customization of information for a number of regional websites that are operated by the network-based system 112 and that are accessible via respective web servers.

Reputation applications 234 allow users that transact, utilizing the network-based system 112, to establish, build and maintain reputations, which may be made available and published to potential trading partners. Consider that where, for example, the network-based system 112 supports person-to-person trading, users may otherwise have no history or other reference information whereby the trustworthiness and credibility of potential trading partners may be assessed. The reputation applications 234 allow a user, for example through feedback provided by other transaction partners, to establish a reputation within the network-based system 112 over time. Other potential trading partners may then reference such a reputation for the purposes of assessing credibility and trustworthiness.

In order to make listings, available via the network-based system 112, as visually informing and attractive as possible, the marketplace applications 130 may include one or more imaging applications 236 utilizing which users may upload images for inclusion within listings. An imaging application 236 also operates to incorporate images within viewed listings. The imaging applications 236 may also support one or more promotional features, such as image galleries that are presented to potential buyers. For example, sellers may generally pay an additional fee to have an image included within a gallery of images for promoted items.

The marketplace application(s) 130 may include one or more offer creation applications 238. The offer creation applications 238 allow sellers conveniently to author products pertaining to goods or services that they wish to transact via the network-based system 112. Offer management applications 240 allow sellers to manage offers, such as goods, services, or donation opportunities. Specifically, where a particular seller has authored and/or published a large number of products, the management of such products may present a challenge. The offer management applications 240 provide a number of features (e.g., auto-reproduct, inventory level monitors, etc.) to assist the seller in managing such products. One or more post-offer management applications 242 also assist sellers with a number of activities that typically occur post-offer. For example, upon completion of an auction facilitated by one or more auction applications 212, a seller may wish to leave feedback regarding a particular buyer. To this end, a post-offer management application 242 may provide an interface to one or more reputation applications 234, so as to allow the seller conveniently to provide feedback regarding multiple buyers to the reputation applications 234.

The dispute resolution application(s) 246 may provide mechanisms whereby disputes arising between transacting parties may be resolved. For example, the dispute resolution applications 48 may provide guided procedures whereby the parties are guided through a number of steps in an attempt to settle a dispute. In the event that the dispute cannot be settled via the guided procedures, the dispute may be escalated to a mediator or arbitrator.

The fraud prevention application(s) 248 may implement various fraud detection and prevention mechanisms to reduce the occurrence of fraud within the network-based system 112. The fraud prevention application(s) may prevent fraud with respect to the third party and/or the client user in relation to any part of the request, payment, information flows and/or request fulfillment. Fraud may occur with respect to unauthorized use of financial instruments, non-delivery of goods, and abuse of personal information.

Authentication application(s) 250 may verify the identity of a user, and may be used in conjunction with the fraud prevention application(s) 248. The user may be requested to submit verification of identity, an identifier upon making the purchase request, for example. Verification may be made by a code entered by the user, a cookie retrieved from the device, a phone number/identification pair, a username/password pair, handwriting, and/or biometric methods, such as voice data, face data, iris data, finger print data, and hand data. In some embodiments, the user may not be permitted to login without appropriate authentication. The system (e.g., the FSP) may automatically recognize the user, based upon the particular network-based device used and a retrieved cookie, for example.

The network-based system 112 itself, or one or more parties that transact via the network-based system 112, may operate loyalty programs and other types of promotions that are supported by one or more loyalty/promotions applications 254. For example, a buyer/client user may earn loyalty or promotions points for each transaction established and/or concluded with a particular seller/third party, and may be offered a reward for which accumulated loyalty points can be redeemed.

The application server(s) 128 may include messaging applications 256. The messaging applications 256 are responsible for the generation and delivery of messages to client users and third parties of the network-based system 112. Information in these messages may be pertinent to services offered by, and activities performed via, the payment application(s) 132.

Such messages, for example, advise client users regarding the status of products (e.g., providing “out of stock” or “outbid” notices to client users) or payment status (e.g., providing invoice for payment, Notification of a Payment Received, delivery status, invoice notices). Third parties may be notified of a product order, payment confirmation and/or shipment information. Respective messaging applications 256 may utilize any one of a number of message delivery networks and platforms to deliver messages to users. For example, messaging applications 256 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

The payment application(s) 132 may include one or more payment processing applications 258. The payment processing application(s) 258 may receive electronic invoices from the merchants and may receive payments associated with the electronic invoices. The payment application(s) 132 may also make use of functions performed by some applications included in the marketplace application(s) 130.

### Payment Processing Applications

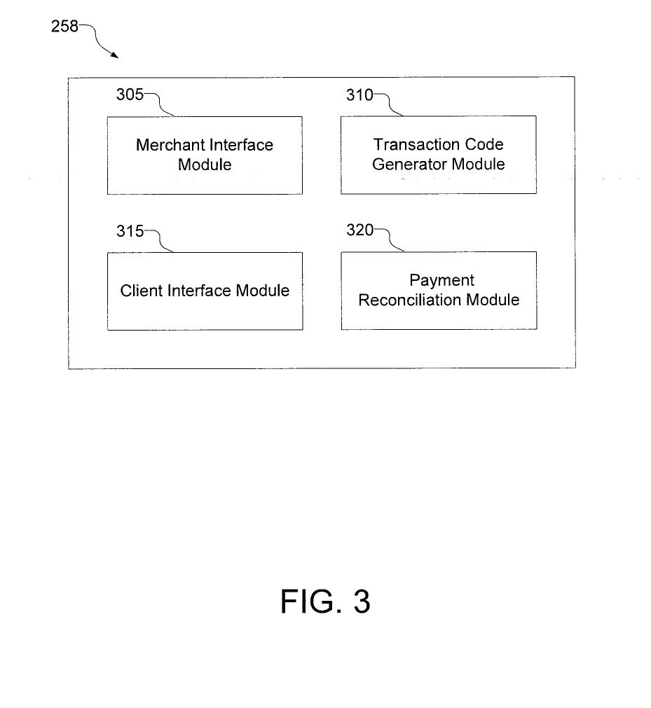

FIG. 3 illustrates a high-level diagram of the payment processing applications, in accordance with some example embodiments. The payment processing application(s) 258 may include a merchant interface module 305 to communicate with a merchant computer system such as, for example, the third party server 140 illustrated in FIG. 1. The merchant interface module 305 may allow merchants to sign on to the payment processing application(s) 258 and to transmit electronic invoices to the payment processing application(s) 258. The electronic invoices may be associated with transactions conducted between a merchant and one or more consumers. The electronic invoices may include invoices that are to be paid by pooling payments from multiple consumers. For some example embodiments, the electronic invoices may be generated by the merchant computer system. For some example embodiments, the merchant may indicate to the payment processing application(s) 258 that an electronic invoice is to be paid by multiple consumers. This notification may be transmitted to the payment processing application(s) 258 during the same time period when the electronic invoice is transmitted to the payment processing application(s) 258.

The payment processing application(s) 258 may include a transaction code generator module 310. The transaction code generator module 310 may accept the electronic invoices received from the merchants (via the merchant interface module 305) and may generate a unique transaction code. The unique transaction code may include information to identify the merchant as well as information to identify an electronic invoice received from the merchant. The unique transaction code may be transmitted to the merchant via the merchant interface module 305. For some example embodiments, the merchant may then provide the transaction code to the one or more consumers. For some example embodiments, the transaction code may be transmitted from a merchant computer system to a client computer system. For some example embodiments, the merchant may also provide or transmit a copy of the electronic invoice to the one or more consumers.

The payment processing application(s) 258 may include a client interface module 315. The client interface module 315 may enable the payment processing application(s) 258 to communicate with a client system such as, for example, the client system 120 illustrated in FIG. 1. The client interface module 315 may allow a consumer to sign on to the payment processing application(s) 258 and to transmit payment request to the payment processing application(s) 258. For some example embodiments, a consumer may transmit the transaction code received from the merchant to the payment processing application(s) 258. For some example embodiments, responsive to receiving the transaction code from the client system 120, the payment processing application(s) 258 may transmit a copy of the electronic invoice associated with the transaction code to the client system via the client interface module 315. When an amount associated with the electronic invoice is to be paid by pooling payments from multiple consumers, the process of transmitting the transaction code to the payment processing application(s) 258 may be performed using multiple client system 120, with each of the multiple client system 120 being associated with each of the multiple consumers. In these situations, the payment processing application(s) 258 may transmit a copy of the electronic invoice to each of the client system 120. A consumer associated with a client system may review the electronic invoice and may transmit a payment request to the payment processing application(s) 258 to authorize the payment processing application(s) 258 to make a payment to the merchant. When pooling payments from multiple consumers, each of the consumers may transmit a separate payment request to the payment processing application(s) 258. For some example embodiments, each of the consumers may review the electronic invoice and may determine whether to pay a portion of the amount (also referred to as a sub-payment) associated with the electronic invoice or for the entire amount. The consumer may then transmit a payment request indicating an amount that the consumer authorizes the payment processing application(s) 258 to pay.

The payment processing application(s) 258 may include a payment reconciliation module 320. The payment reconciliation module 320 may reconcile all payment requests when pooling payments from multiple consumers. For some example embodiments, when there is only one consumer responsible for the entire amount associated with the electronic invoice and the payment request received from the consumer covers the entire amount, the payment reconciliation module 320 may notify the merchant that the payment is to be processed. For some example embodiments, when there are multiple consumers responsible for the amount associated with the electronic invoice and the payment request received from one consumer covers the entire amount, the payment reconciliation module 320 may also notify the merchant that the payment is to be processed. For some example embodiments, when the payment processing application(s) 258 receives a first payment request for less than the amount associated with the electronic invoice, the payment processing application(s) 258 may automatically recognize that there may be multiple consumers paying for the electronic invoice and may wait for additional payment requests from the other consumers. The payment reconciliation module 320 may add the payments associated with the multiple payment requests to determine whether the entire amount of the electronic invoice is covered. For some example embodiments, the payment reconciliation module 320 may notify the merchant (via the merchant interface module 305) whether the entire amount of the electronic invoice is covered. The merchant may then notify the consumers that the pooled payments are not sufficient and that additional payment requests may need to be made. It may be noted that the merchant and the consumers may need to be members of the payment facilitator to be able to sign on to the payment processing application(s) 258.

### Transaction Diagram

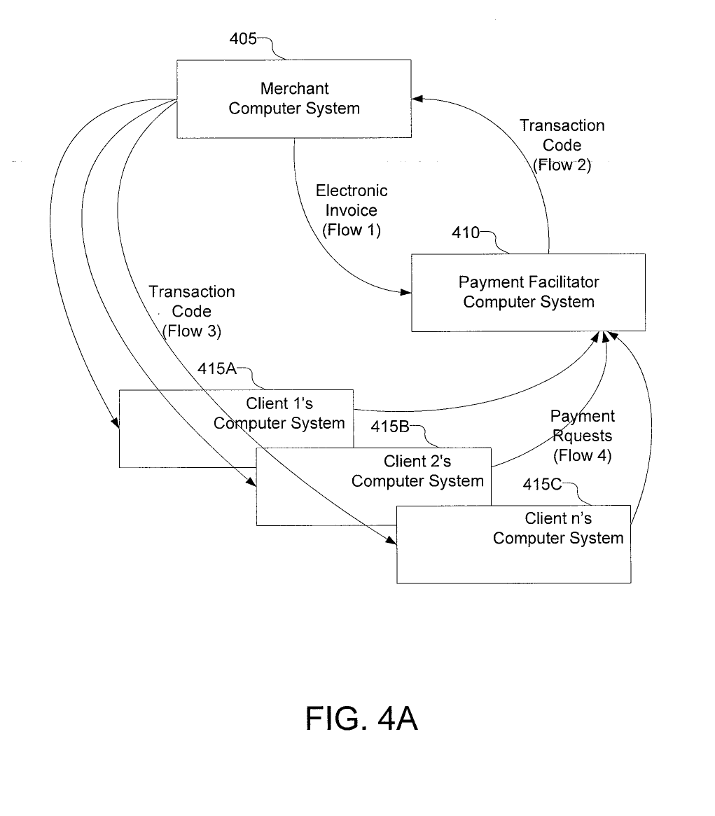

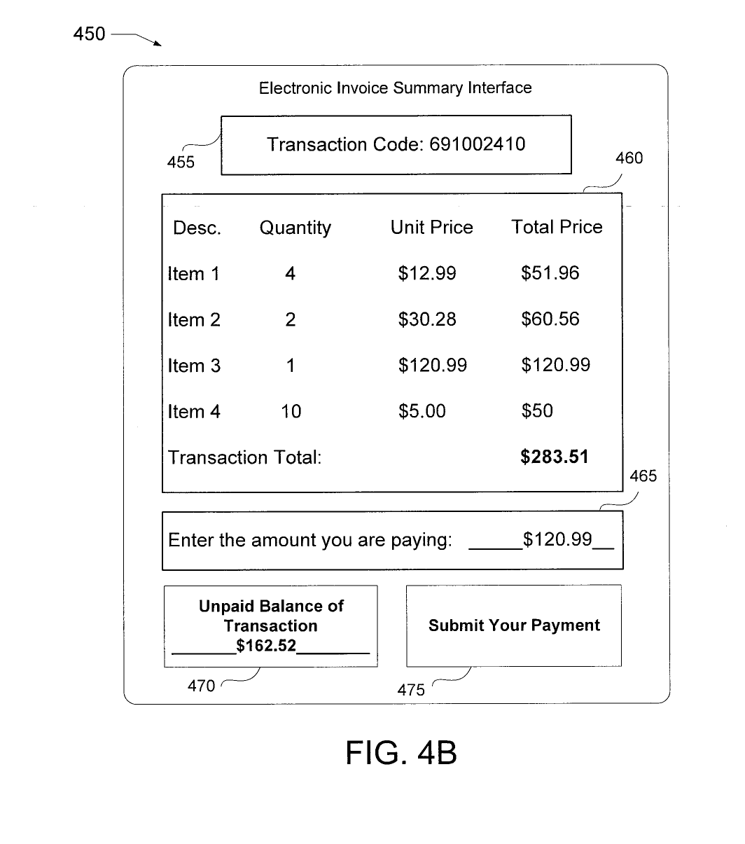

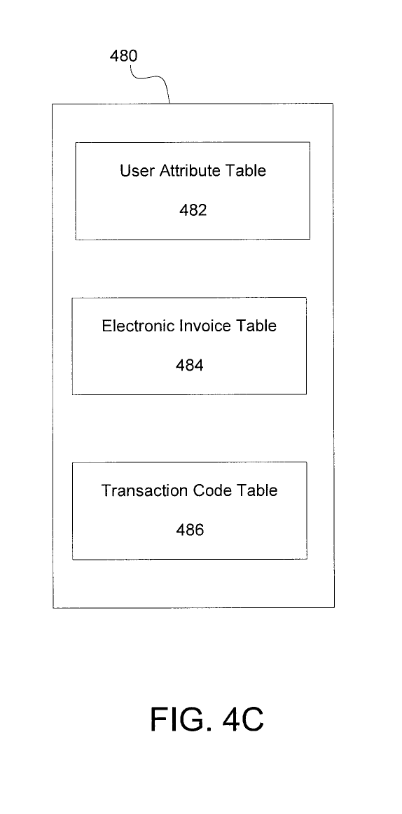

FIG. 4A is a diagram that illustrates examples of information flow, in accordance with some example embodiments. The diagram includes three groups of computer systems: merchant computer system(s) 405, payment facilitator computer system 410, and client computer system(s) 415A-415C. For payment transactions where pooling of payments is applicable, a first flow of information may be originated from the merchant computer system 405 and transmitted to the payment facilitator computer system 410. The first flow of information may include an electronic invoice. Responsive to receiving the first flow of information by the payment facilitator computer system 410, a second flow of information may be originated from the payment facilitator computer system 410 and transmitted to the merchant computer system 405. The second flow of information may include a transaction code. Responsive to receiving the transaction code by the merchant computer system 405, a third flow of information may be originated from the merchant computer system 405 and transmitted to the client computer systems 415A-415C. The third flow of information may include the transaction code. Responsive to receiving the transaction code by one or more of the client computer systems 415A-415C, a fourth flow of information may be originated from one or more of the client computer systems 415A-415C and transmitted to the payment facilitator computer system 410. The fourth flow of information may include payment requests and/or payment authorization. For some example embodiments, the payment facilitator computer system 410 may transmit payment status information to the merchant computer system 405. The payment status information may include, for example, notification that the payment is complete or incomplete, etc.

### User Interface

FIG. 4B illustrates an example of a user interface that may be used, in accordance with some example embodiments. User interface 450 may be referred to as an electronic invoice summary interface. The user interface 450 may be used with a client system 120. The user interface 450 may include a transaction code display area 455 to display a transaction code associated with an electronic invoice. The transaction code may be received from a merchant associated with the electronic invoice. The transaction code may be received electronically from a merchant computer system. The transaction code may alternatively be provided by a merchant.

The user interface 450 may include a transaction detail display area 460. The transaction detail display area 460 may include detail information about the electronic invoice. The transaction detail display area 460 may display price and quantity information of items that may be included in the electronic invoice. It may also display item description information and total price information. In the current example, the transaction detail display area 460 displays four items, each with its associated description, quantity, unit price and total price. A transaction total of $283.51 is also displayed.

The user interface 450 may include a payment display area 465. The payment display area 465 may be used by a consumer to enter an amount that the consumer is contributing toward the transaction total. For some example embodiments, a consumer may pay the entire transaction total or a portion (sub-payment) of the transaction total. In the current example, a portion of the transaction total in the amount of $120.99 is being paid. When there are multiple consumers associated with one electronic invoice, each of the multiple consumers may pay a portion of the electronic invoice. A transaction may be considered to be paid in full when the collective sub-payments of one or more of the consumers add up to an amount at least equals to the transaction total.

The user interface 450 may include a payment balance display area 470. The payment balance display area 470 may display a difference between a transaction total and an amount being paid or entered via the payment display area 465. For example, since the difference between $283.51 and $120.99 is $162.52, the payment balance display area 470 displays a balance of $162.52. For some example embodiments, an amount displayed in the payment balance display area 470 may be a difference between a transaction total and an amount equal to payments made by multiple consumers including the payment paid or entered via the payment display area 465.

The user interface 450 may include a submit selector 475 to enable a consumer to submit an amount entered into the payment display area 465. For example, selecting or activating the submit selector 475 may initiate a session between a client computer system 415A and a payment facilitator computer system 410, illustrated in FIG. 4A. The client computer system 415A may be implemented to include the user interface 450. Each of the display areas described herein may also be referred to as a frame (e.g., payment frame 465).

### Data Structures

FIG. 4C illustrates a high-level entity-relationship diagram, having various tables 480 that may be maintained within the database(s) 136 according to an example embodiment. The tables 480 may be utilized by and support the application(s) of the application server(s). The applications may include payment pooling applications as described herein. The database(s) 136 may, in one embodiment, be implemented as a relational database, and includes a number of tables having entries, or records, that are linked by indices and keys. In an alternative embodiment, the database(s) 136 may be implemented as a collection of objects in an object-oriented database.

The tables 480 may include a user attributes table 482, which may contain a record for each registered user of the network-based system 112. A user may operate as a seller, merchant, a buyer, a consumer, or any combination, within the network-based system 112. In one example embodiment, a buyer may be a user that has accumulated value (e.g., commercial or proprietary currency), and is accordingly able to exchange the accumulated value for items that are offered for sale by the network-based system 112. The user attribute may be selected from a group including: number of feedbacks obtained, positive feedback percentage, verifiable street address on file, time on file (length of time), associated country, listings, user identification information, shipping and/or billing address information (including default address), financial instrument information (including default payment method, currency information), and other information (e.g. wireless carrier) pertaining to each such registered user.

The tables 480 also include electronic invoice tables 484. The electronic invoice tables 484 may include electronic invoices received from various merchants or sellers. An electronic invoice may be associated with a merchant identification. A merchant identification may be associated with multiple electronic invoices. Each electronic invoice may be stored and maintained as a record in the electronic invoice tables 484. One or more of the electronic invoices may be received by the network-based system 112.

The tables 480 may include a transaction code table 486 which may contain a record for each transaction code generated in response to receiving an electronic invoice from a merchant. For some example embodiments, a transaction code may be unique and may be associated with only one electronic invoice. In some other example embodiments, a transaction code may be associated with more than one electronic invoice. For example, two or more group of consumers may want to pool their electronic invoices together so they can share paying for the pooled electronic invoices. This may be applicable when a decision to pool the payments is made after it is too late to put multiple transactions into one electronic invoice.

### Flowcharts

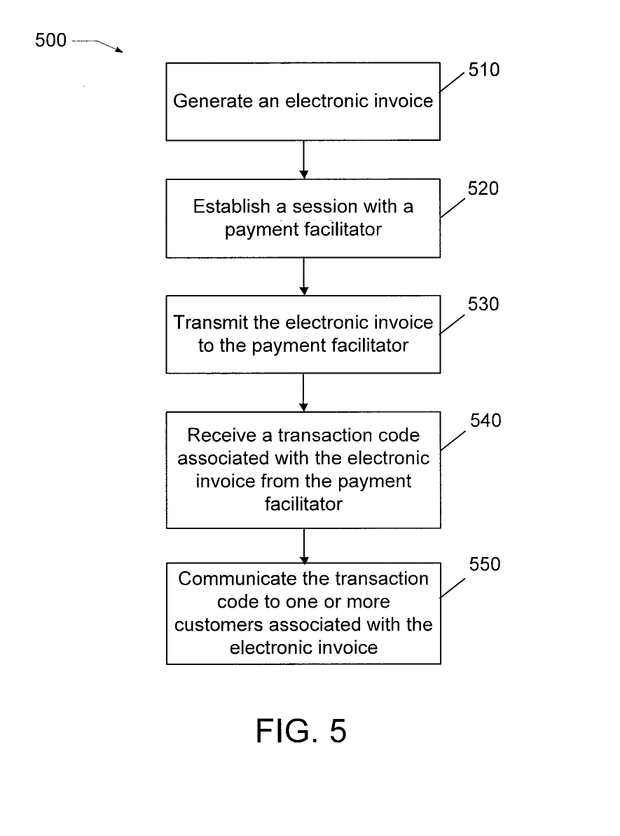

FIG. 5 is a flow chart illustrating an example process for generating a transaction code and providing the transaction code to a consumer, in accordance with some example embodiments. Process 500 may be performed by a merchant computer system using software, hardware or a combination of both. The process 500 may start at block 510 where an electronic invoice may be generated. The electronic invoice may be associated with a transaction between a merchant and one or more consumers. The electronic invoice may be generated by a merchant computer system.

At block 520, a session may be established with a payment facilitator. The session may be between a merchant computer system and a payment facilitator computer system (or payment system). The session may be established over a wired, wireless or a combination of both wired and wireless communication connection.

At block 530, the electronic invoice may be transmitted to the payment facilitator using the communication connection established in block 520. Responsive to receiving the electronic invoice, the payment facilitator computer system may generate a transaction code associated with the electronic invoice. The transaction code may be unique to the electronic invoice and to the merchant. The transaction code may be transmitted by the payment facilitator computer system to the merchant computer system.

At block 540, the transaction code is received. At block 550, the transaction code may be communicated to the one or more consumers associated with the electronic invoice. This may be performed electronically and may be received by a consumer computer system (or consumer system). Alternatively, the transaction code may be provided to the one or more consumers by the merchant.

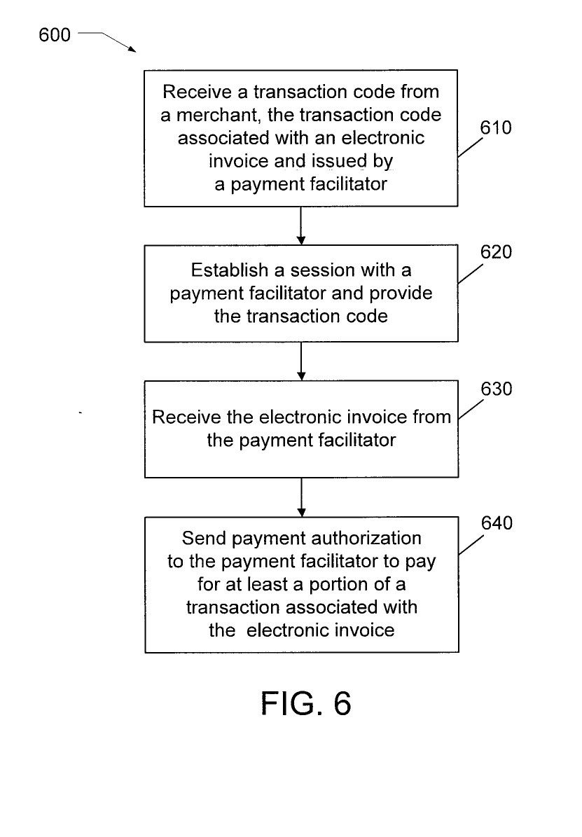

FIG. 6 is a flow chart illustrating an example process for using a payment facilitator and a transaction code to pay an invoice, in accordance with some example embodiments. Process 600 may be performed by a consumer computer system using software, hardware or a combination of both. The process 600 may start at block 610 where a transaction code is received. The transaction code may be associated with an electronic invoice that a consumer is at least partly responsible for. The transaction code may be received electronically or non-electronically.

At block 620, a session may be established with a payment facilitator. The session may be between a consumer computer system and a payment facilitator computer system. The session may be established over a wired, wireless or a combination of both wired and wireless communication connection. The transaction code may be sent from the consumer computer system to the payment facilitator computer system. Responsive to receiving the transaction code, the payment facilitator computer system may retrieve an electronic invoice that is associated with the transaction code. As may be noted, the electronic invoice may have been previously received from a merchant computer system. The electronic invoice may be saved in a database (e.g., database 136). The retrieved electronic invoice may be transmitted to the consumer computer system.

At block 630, the electronic invoice may be received by the consumer computer system. At block 640, a consumer may enter an amount to pay at least a portion of a transaction associated with electronic invoice. For example, the consumer may use the user interface 450 illustrated in FIG. 4B. A payment authorization may then be transmitted from the consumer computer system to the payment facilitator computer system.

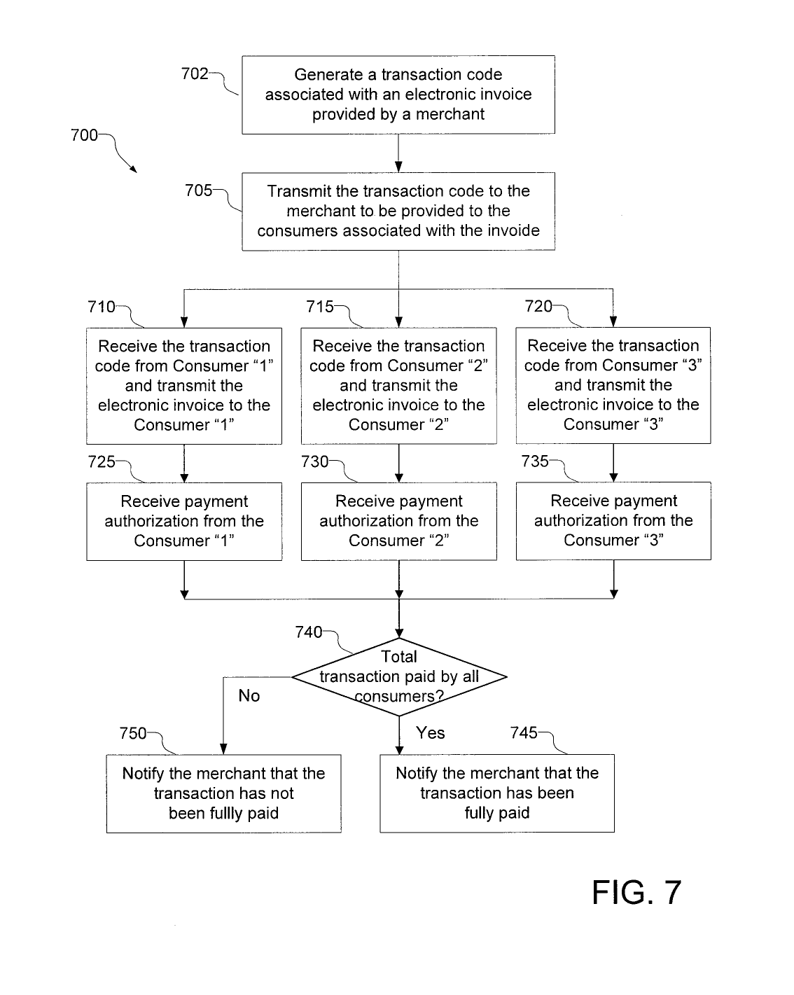

FIG. 7 is a flow chart illustrating an example process for using a payment facilitator and a transaction code to pool multiple payments for a transaction, in accordance with some example embodiments. Process 700 may be performed by a payment facilitator computer system using software, hardware or a combination of both. The process 700 may start at block 702 where a transaction code is generated by a payment facilitator computer system. At block 705, the transaction code is transmitted to a merchant computer system. The transaction code may be transmitted or provided to a group of consumers who desire to pool multiple sub-payments together to pay the electronic invoice.

At blocks 710 and 725, based on the transaction code, the electronic invoice is transmitted to a first consumer and a payment authorization may be received from the first consumer. Similarly, at blocks 715 and 730, the electronic invoice is transmitted to a second consumer and payment authorization may be received from the second consumer. Likewise, at blocks 720 and 735, the electronic invoice is transmitted to a third consumer and payment authorization may be received from the third consumer. It may be noted that the number of consumers in a group may two or more, even though the current example uses only three consumers.

At block 740, a determination is made to find out if the payments received from the different consumers satisfy the transaction. If the transaction is satisfied by the payments, the process may flow to block 745 where a positive notification may be generated and transmitted to the merchant computer system. From block 740, if the transaction is not satisfied by the payments, the process may flow to block 750 where a negative notification may be generated and transmitted to the merchant computer system.

### Platform Architecture

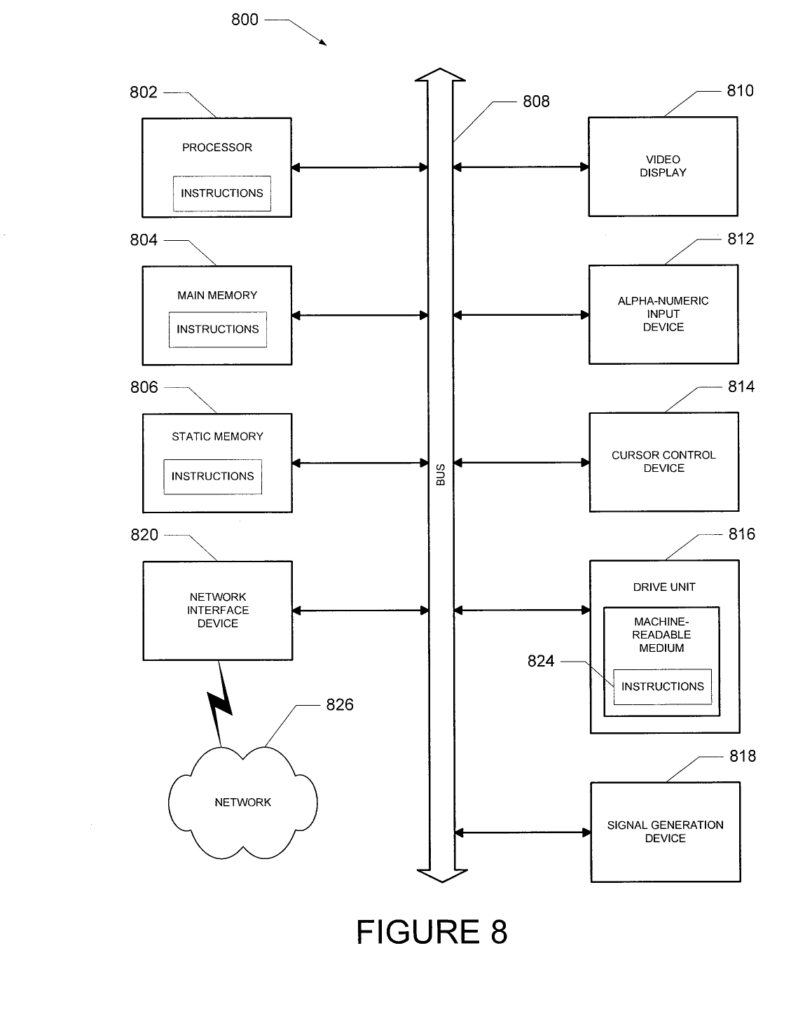

FIG. 8 shows a diagrammatic representation of a machine in the example form of a computer system 800 within which a set of instructions, for causing the machine to automatically perform any one or more of the methodologies discussed herein, may be executed. In alternative embodiments, the machine operates as a standalone device or may be connected (e.g., network) to other machines. In a network deployment, the machine may operate in the capacity of a server or a client user machine in server-client user network environment, or as a peer machine in a peer-to-peer (or distributed) network environment. The machine may be a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a television, television cable a pager, a personal trusted device, a web appliance, a network router, switch or bridge, or any machine capable of executing a set of instructions (sequential or otherwise) that specify actions to be taken by that machine.

Further, while a single machine is illustrated, the term “machine” shall also be taken to include any collection of machines that individually or jointly execute a set (or multiple sets) of electronically-coded instructions to perform any one or more of the methodologies discussed herein.

The example computer system 800 includes a processor 802 (e.g., a central processing unit (CPU), a graphics processing unit (GPU), or both), a main memory 804 and a static memory 806, which communicate with each other via a bus 808. The computer system 800 may further include a video display unit 810 (e.g., a liquid crystal displays (LCD) or a cathode ray tube (CRT)). The computer system 800 also includes an input device 812 (e.g., a keyboard), a cursor control device 814 (e.g., a mouse), a disk drive unit 816, a signal generation device 818 (e.g., a speaker) and a network interface device 820.

The disk drive unit 816 includes a machine-readable medium 822 on which is stored one or more sets of electronically-coded instructions (e.g., software 824) embodying any one or more of the methodologies or functions described herein. The instructions 824 may also reside, completely or at least partially, within the main memory 804, the static memory 806, and/or within the processor 802 during execution thereof by the computer system 800. The main memory 804 and the processor 802 also may constitute machine-readable media.

The instructions 824 may further be transmitted or received over a network 826 via the network interface device 820.

Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. FIGS. 1 to 8 are merely representational and may not be drawn to scale. Certain proportions thereof may be exaggerated, while others may be minimized.

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The description includes terms, such as “up”, “down”, “upper”, “lower”, “first”, “second”, etc. that are used for descriptive purposes only and are not to be construed as limiting. The elements, materials, geometries, dimensions, and sequence of operations may all be varied to suit particular applications. Parts of some embodiments may be included in, or substituted for, those of other embodiments. While the examples of dimensions and ranges are considered typical, the various embodiments are not limited to such dimensions or ranges.

The Abstract is provided to comply with 37 C.F.R. §1.74(b) to allow the reader to quickly ascertain the nature and gist of the technical disclosure. The Abstract is submitted with the understanding that it will not be used to interpret or limit the scope or meaning of the claims. In the Detailed Description, various features are grouped together in a single embodiment for the purpose of streamlining the disclosure. This method of disclosure is not to be interpreted as reflecting an intention that the claimed embodiments have more features than are expressly recited in each claim. Thus, the following claims are hereby incorporated into the Detailed Description, with each claim standing on its own as a separate embodiment.

What is claimed is:

1. A system comprising:
a payment system associated with a payment facilitator;
a merchant system associated with a merchant and coupled to the payment system, the merchant system configured to transmit an electronic invoice to the payment system and to receive a transaction code associated with the electronic invoice from the payment system; and
two or more consumer systems coupled to the payment system, the two or more consumer systems associated with consumers of the merchant and configured to transmit the transaction code to the payment system and to receive the electronic invoice from the payment system, wherein the payment system, the merchant system and the two or more consumer systems are communicatively coupled to a network.

2. The system of claim 1, wherein each of the two or more consumer systems is configured to transmit an authorization to pay at least a portion of the electronic invoice to the payment system.

3. The system of claim 2, wherein the payment system is configured to send a payment status notification to the merchant system responsive to receiving one or more authorizations from the two or more consumer systems.

4. The system of claim 3, wherein the payment status notification indicates whether the transaction is covered.

5. The system of claim 3, wherein each of the two or more consumer systems is configured to receive the transaction code from the merchant system.

6. The system of claim 5, wherein each of the two or more consumer systems is configured to receive the electronic invoice from the payment system after transmitting the transaction code to the payment system.

7. The system of claim 6, wherein the transaction code is unique.

8. The system of claim 6, wherein at least one of the consumer systems is a wireless computer system.

9. The system of claim 6, wherein at least one of the consumer systems is a portable computer system.

10. A method, comprising:
generating an electronic invoice associated with a transaction;
transmitting the electronic invoice to a payment system;
receiving a transaction code associated with the electronic invoice from the payment system;
transmitting the transaction code to two or more consumer systems for payment; and
receiving the payment via the payment system, wherein the payment is formed by pooling multiple sub-payments associated with the two or more computer systems.

11. The method of claim 10, wherein the two or more consumer systems includes a first consumer system and a second consumer system, wherein the first consumer system is associated with a first sub-payment, and wherein the second consumer system is associated with a second sub-payment.

12. The method of claim 11, wherein authorization for the first sub-payment is transmitted from the first consumer system to the payment system after the first consumer system receives the electronic invoice from the payment system.

13. The method of claim 12, wherein the first consumer system receives the electronic invoice from the payment system in response the payment system receiving the transaction code from the first consumer system.

14. The method of claim 10, further comprising:
establishing a communication session with the payment system.

15. A method, comprising:
receiving an electronic invoice from a merchant system;
transmitting the electronic invoice to two or more consumer systems; and
receiving two or more payment authorizations from the two or more consumer systems, wherein the two or more payment authorizations are to cover at least a portion of the electronic invoice.

16. The method of claim 15, further comprising:
responsive to receiving the electronic invoice from the merchant system, generating a transaction code; and
transmitting the transaction code to the merchant system.

17. The method of claim 16, wherein the electronic invoice is transmitted to the two or more consumer systems responsive to receiving the transaction code from the two or more consumer systems.

18. The method of claim 17, wherein the two or more consumer systems receive the transaction code from the merchant system.

19. A method, comprising:
establishing a communication session with a payment system;
transmitting a transaction code to the payment system;
receiving an electronic invoice associated with the transaction code from the payment system, the electronic invoice previously received by the payment system from a merchant system; and
transmitting a payment authorization to the payment system to cover at least a portion of the electronic invoice.

20. The method of claim 19, further comprising:
receiving the transaction code from the merchant system.

21. The method of claim 20, wherein the transaction code is received from the merchant system using a wireless connection.

22. A payment user interface, comprising:
a first frame to display information related to an electronic invoice;
a second frame to display a transaction code associated with the electronic invoice;
a third frame to receive payment information related to the electronic invoice, wherein the payment information covers at least a portion of the electronic invoice; and
a fourth frame to enable transmitting payment authorization using the payment information received in the third frame.

23. The payment user interface of claim 22, wherein the information related to the electronic invoice is received from a payment system over a network connection, and wherein the payment authorization is transmitted to the payment system over the network connection.

24. The payment user interface of claim 23, wherein the electronic invoice is generated by a merchant system, and wherein the transaction code is generated by the payment system after receiving the electronic invoice from the merchant system.

25. A machine-readable medium comprising instructions, which when implemented by one or more processors perform the following operations:
receiving an electronic invoice from a merchant system, the electronic invoice associated with a transaction between the merchant and a first consumer and a second consumer;
generating a transaction code associated with the electronic invoice;
transmitting the transaction code to the merchant system;
transmitting the electronic invoice to a first consumer system associated with the first consumer and to a second consumer system associated with the second consumer;
receiving authorization from the first consumer system to pay a first portion of the electronic invoice; and
receiving authorization from the second consumer system to pay a second portion of the electronic invoice.

26. The machine-readable medium of claim 25, further comprising:
receiving the transaction code from the first consumer system before transmitting the electronic receipt to the first consumer system; and
receiving the transaction code from the second consumer system before transmitting the electronic receipt to the second consumer system.

27. The machine-readable medium of claim 26, further comprising:
storing the electronic receipt after receiving the electronic receipt from the merchant system; and
processing the authorizations received from the first consumer system and the second consumer system to pay the merchant based at least on the first portion and the second portion.
